(19) United States
(12) Patent Application Publication
(10) Pub. No.: US 2025/0189791 A1
(43) Pub. Date: Jun. 12, 2025

(54) HEAD-UP DISPLAY DEVICE

(71) Applicant: Yazaki Corporation, Tokyo (JP)

(72) Inventors: Naohisa MURATA, Shizuoka (JP); Tomohiro Miyazawa, Shizuoka (JP)

(73) Assignee: Yazaki Corporation, Tokyo (JP)

(21) Appl. No.: 19/061,047

(22) Filed: Feb. 24, 2025

Related U.S. Application Data
(63) Continuation of application No. PCT/JP2023/035228, filed on Sep. 27, 2023.

(30) Foreign Application Priority Data
Sep. 29, 2022 (JP) 2022-155994

(51) Int. Cl. G02B 27/01

(52) U.S. Cl. CPC G02B 27/0101; G02B 2027/011; G02B 2027/013

(57) ABSTRACT

In a head-up display device, a transparent cover includes an inner surface portion positioned on a reflection mirror side, and an external side surface portion positioned on an opposite side of the reflection mirror side. Here, display light guided to an eye point includes a regular light transmitted through the transparent cover without being reflected by the inner surface portion and the outer surface portion of the transparent cover, and guided to the eye point, and irregular light transmitted through the transparent cover after being reflected by the inner surface portion and the outer surface portion of the transparent cover, and guided to the eye point. The inner surface portion of the transparent cover has an incidence surface with an incidence angle of 65° or less. The incidence angle is an angle at which the irregular light enters the incidence surface.

### CROSS-REFERENCE TO RELATED APPLICATION(S)

This application is a continuation application of International Application No. PCT/JP2023/035228 filed on Sep. 27, 2023 which claims the benefit of priority from Japanese Patent Application No. 2022-155994 filed on Sep. 29, 2022 and designating the U.S., the entire contents of which are incorporated herein by reference.

### BACKGROUND OF THE INVENTION

### 1. Field of the Invention

The present invention relates to a head-up display device.

### 2. Description of the Related Art

Conventionally, as a head-up display device, for example, Japanese Patent Application Laid-open No. 2006-91104 has described a vehicle head-up display that displays a virtual image via a front window shield of a vehicle. This vehicle head-up display is arranged on an instrument panel of the vehicle, and includes a housing having an opening from which image light of an image is emitted, a display instrument that is accommodated in the housing, and emits image light of the image, a magnifier that is accommodated in the housing, and enlarges and reflects an image directly emitted from the display instrument, and a lens that blocks the opening of the housing, and enlarges and outputs the image emitted from the magnifier, to the front windshield.

On the other hand, in the vehicle head-up display device described in Japanese Patent Application Laid-open No. 2006-91104 above, for example, there is a concern that light propagating in the lens is visually recognized as a double image by being guided to an eye point of an occupant.

### SUMMARY OF THE INVENTION

Thus, the present invention has been devised in view of the foregoing, and the object of the present invention is to provide a head-up display device that can appropriately display a virtual image.

In order to achieve the above mentioned object, a head-up display device according to one aspect of the present invention includes a display unit that is provided in a vehicle and that display a virtual image by reflecting display light emitted toward a reflection member capable of transmitting light, by the reflection member toward an eye point side; and a housing having an opening facing the reflection member, to which the display unit is assembled, wherein the display unit includes a display instrument that is accommodated inside the housing, and emits the display light, a reflection mirror that is accommodated inside the housing, and reflects enlarged display light obtained by enlarging the display light emitted from the display instrument, toward the reflection member via the opening, and a transparent cover that blocks the opening, and transmits the enlarged display light reflected by the reflection mirror, the transparent cover includes a first surface portion positioned on the reflection mirror side, and a second surface portion positioned on an opposite side of the reflection mirror side, the display light guided to the eye point includes regular light transmitted through the transparent cover without being reflected by the first surface portion and the second surface portion of the transparent cover, and guided to the eye point, and irregular light transmitted through the transparent cover after being reflected by the first surface portion and the second surface portion of the transparent cover, and guided to the eye point, and the first surface portion of the transparent cover has an incidence surface with an incidence angle of 65° or less, the incidence angle being an angle at which the irregular light enters the first surface portion, and the incidence surface causes the irregular light to enter at an angle that sets the luminance of the irregular light with respect to the luminance of the regular light, to 2% or less.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration example of a head-up display device according to an embodiment;

FIG. 2 is a perspective view illustrating a configuration example of a transparent cover according to the embodiment; and

FIG. 3 is a schematic diagram illustrating regular light and irregular light according to the embodiment.

### DETAILED DESCRIPTION OF THE PREFERRED EMBODIMENTS

A mode for carrying out the present invention (embodiment) will be described in detail with reference to the drawings. The present invention is not limited by the content described in the following embodiment. In addition, components described below include the ones easily-conceived by those skilled in the art, or the ones that are substantially identical. Furthermore, configurations described below can be appropriately combined. In addition, various omissions, substitutions, or modifications of configurations can be performed without departing from the scope of the present invention.

### Embodiment

A head-up display device 1 according to an embodiment will be described with reference to the drawings. The head-up display device 1 is provided in a vehicle, and displays a virtual image S by reflecting display light L1 emitted toward a window shield WS that can transmit light, on the window shield WS toward an eye point EP side. Here, the window shield WS is an example of a reflection member, is a member formed of transparent glass into a plate shape, is provided in front of a driver's seat, and shields wind. The head-up display device 1 may be an augmented reality head-up display (AR-HUD) device that superimpose-displays the virtual image S in alignment with a target object (e.g., person, label, another vehicle, etc.) existing in front of the vehicle, or may be a head-up display (HUD) device that displays the virtual image S without aligning the virtual image S with the target object existing in front of the vehicle. Hereinafter, the head-up display device 1 will be described in detail.

Here, a direction running along a vehicle width direction of the vehicle will be referred to as a first direction X, a direction running along a total length direction of the vehicle will be referred to as a second direction Y, and a direction running along an up-down direction of the vehicle will be referred to as a third direction Z. The second direction Y can also be said to be a direction running along a direct advance direction in which the vehicle goes straight ahead. The third direction Z can also be said to be a vertical direction. The first direction X, the second direction Y, and the third direction Z intersect with each other, and are typically orthogonal to each other. In addition, the first direction X and the second direction Y can also be said to be directions running along a horizontal surface that are orthogonal to each other in the vertical direction.

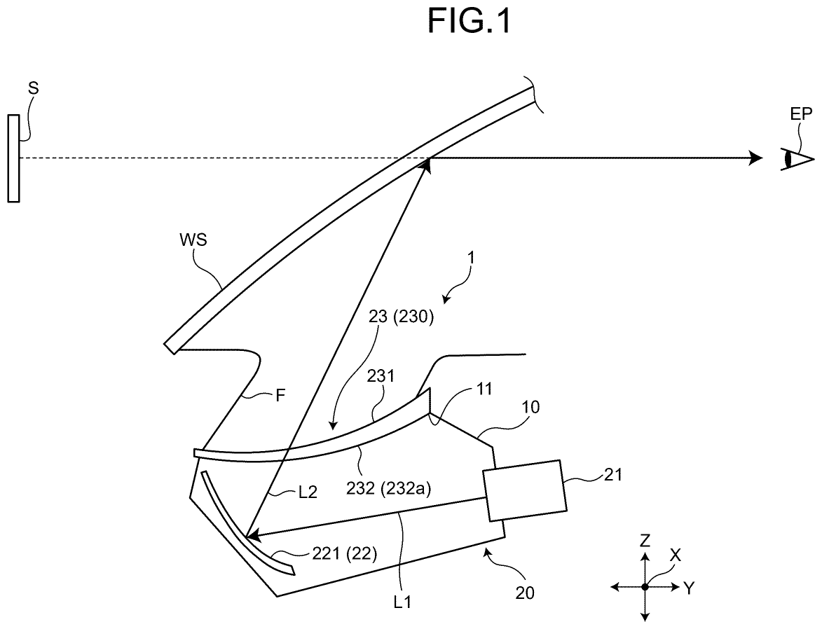

As illustrated in FIG. 1, the head-up display device 1 includes a housing 10 and a display unit 20.

The housing 10 is provided on the vehicle, and the display unit 20 is assembled thereto. The housing 10 is formed into a box shape, and a display instrument 21 and a reflection mirror 22 of the display unit 20, which will be described later, are accommodated inside the housing 10. The housing 10 has an opening 11 that communicates the inside and the outside. The opening 11 is a portion that is provided with facing the window shield WS, and can transmit light.

The display unit 20 displays the virtual image S by reflecting the display light L1 emitted toward the window shield WS, on the window shield WS toward the eye point EP side. The display unit 20 includes the display instrument 21, the reflection mirror 22, and a transparent cover 23.

The display instrument 21 emits the display light L1 including an image, and is accommodated in the housing 10. The display instrument 21 includes, for example, a display and a backlight. The display forms an image, and includes, for example, a thin film transistor-liquid crystal display (TFT-LCD) or the like. The backlight emits light to the back surface of the display, and includes, for example, a plurality of light-emitting diodes (LEDs). By emitting light to the display using the backlight, the display instrument 21 emits the display light L1 including an image, from the display toward the reflection mirror 22. The display instrument 21 directly emits the display light L1 to the reflection mirror 22 not via another mirror, for example. That is, an optical component is not interposed between the display instrument 21 and the reflection mirror 22.

In addition, in the display instrument 21 in this example, a part of the display instrument 21 is accommodated inside the housing 10, and the other part of the display instrument 21 is exposed to the outside of the housing 10. Specifically, an emission unit (e.g., display) of the display instrument 21 that emits the display light L1 is accommodated inside the housing 10, and the part (e.g., backlight) other than the emission unit of the display instrument 21 is exposed to the outside of the housing 10.

The reflection mirror 22 totally reflects light, and is accommodated inside the housing 10. The reflection mirror 22 has a reflection surface 221 formed into a concave shape and on an aspheric surface. The reflection surface 221 is arranged with facing the display instrument 21, and arranged with facing the transparent cover 23. By the reflection surface 221, the reflection mirror 22 enlarges the display light L1 (image) emitted from the display instrument 21, and reflects enlarged display light L2 obtained by the enlargement, toward the window shield WS via the opening 11 (the transparent cover 23) of the housing 10. Specifically, by the reflection surface 221, the reflection mirror 22 enlarges the display light L1 directly emitted from the display instrument 21 not via another mirror, and reflects the enlarged display light L2 obtained by the enlargement, toward the window shield WS via the opening 11 (the transparent cover 23) of the housing 10.

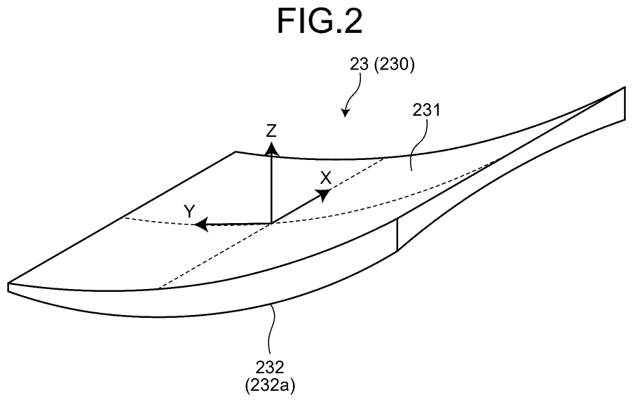

The transparent cover 23 is a cover that blocks the opening 11 of the housing 10 and transmits light. The transparent cover 23 is formed of transparent resin into a curved plate shape, and blocks the opening 11. The transparent cover 23 includes a curved portion 230 formed into a curved shape toward the inside of a housing 2. That is, the curved portion 230 is formed into a concave shape toward the inside of the housing 2. As illustrated in FIG. 2, the curved portion 230 has an outer surface portion 231 serving as a second surface portion, and an inner surface portion 232 serving as a first surface portion.

The outer surface portion 231 is a surface portion positioned on an opposite side of the reflection mirror 22 side, and formed with curving toward the inside of the housing 2. That is, the outer surface portion 231 is a surface portion provided on the window shield WS side. The outer surface portion 231 reflects external light toward a facing portion F. Here, the facing portion F shields light, and is vertically installed on the opposite side of the eye point EP side of the opening 11. That is, the facing portion F is a wall portion provided with extending along the third direction Z on the opposite side of the eye point EP side of the transparent cover 23. In this example, the facing portion F is provided with slightly slanted toward the transparent cover 23 side. The outer surface portion 231 is formed into a shape that reflects external light emitted from the outside of the housing 2, toward the facing portion F. For example, the shape of the outer surface portion 231 is curved in a direction similar to the inner surface portion 232 for external light countermeasure. That is, the shape of the outer surface portion 231 is curved along the shape of the inner surface portion 232. Specifically, the outer surface portion 231 has an XZ cross-section that is cut along the first direction X and the third direction Z, and linearly formed without curving. In addition, the outer surface portion 231 has a YZ cross-section that is cut along the second direction Y and the third direction Z and formed into a curved shape, and is formed into a curved shape at a curvature that can reflect external light toward the facing portion F. The outer surface portion 231 reflects external light emitted from the outside of the housing 2, toward the facing portion F.

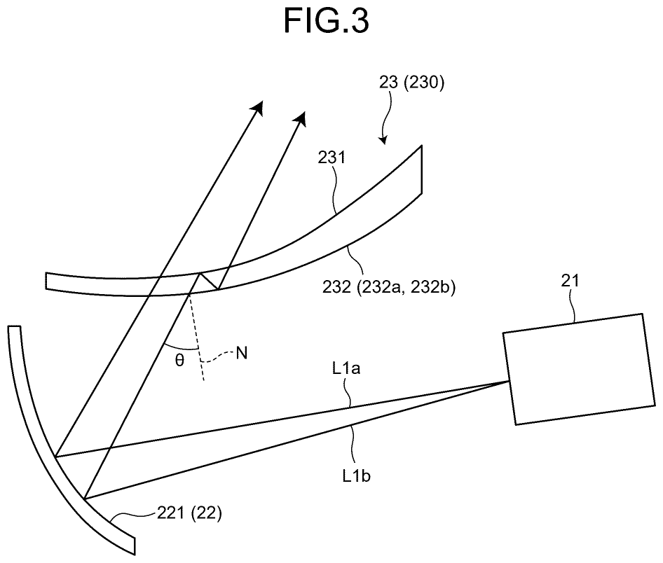

The inner surface portion 232 is a surface portion positioned on the reflection mirror 22 side, and formed with curving toward the inside of the housing 2. That is, the inner surface portion 232 is a surface portion provided on the opposite side of the window shield WS side. As illustrated in FIG. 3, the inner surface portion 232 has an incidence surface 232b that the enlarged display light L2 reflected by the reflection mirror 22 enters. A free curved surface 232a is formed on the incidence surface 232b. The free curved surface 232a is a curved surface that cannot be represented by a simple formula, like a sphere, a cylinder, or the like. The free curved surface 232a is a curved surface represented by setting a plurality of intersections and a plurality of curvatures in a space, and interpolating the intersections by a high-degree polynomial, for example. The free curved surface 232a is formed into a shape that corrects aberration of the virtual image S that is caused by an optical member including the window shield WS and the like. The free curved surface 232a is formed into a shape that corrects aberration of the virtual image S that is caused due to the shape of the window shield WS, for example. By the free curved surface 232a, the transparent cover 23 performs aberration correction on the enlarged display light L2 reflected by the reflection mirror 22. Then, the transparent cover 23 emits the corrected enlarged display light L2 on which aberration correction has been performed by the free curved surface 232a, toward the window shield WS. The corrected enlarged display light L2 emitted toward the window shield WS is reflected by the window shield WS toward the eye point EP side and guided to the eye point EP.

Here, as illustrated in FIG. 1, by emitting light to the display (e.g., TFT-LCD) using the backlight, the display instrument 21 emits the display light L1 including an image, from the display toward the reflection mirror 22. At this time, the display instrument 21 radially emits light (light rays) from individual pixels (dots) of a liquid crystal forming the display. Thus, as illustrated in FIG. 3, the display light L1 guided to the eye point EP sometimes includes regular light L1a and irregular light L1b different from the regular light L1a. Here, the regular light L1a is light transmitted through the transparent cover 23 without being reflected by the inner surface portion 232 and the outer surface portion 231 of the transparent cover 23, and guided to the eye point EP. That is, the regular light L1a is light guided to the eye point EP without being reflected inside the transparent cover 23. The irregular light L1b is light emitted from pixels (dots) of the same liquid crystal as the regular light L1a, and is light transmitted through the transparent cover 23 after being reflected by the inner surface portion 232 and the outer surface portion 231 of the transparent cover 23, and guided to the eye point EP. That is, the irregular light L1b is light emitted from pixels (dots) of the same liquid crystal as the regular light L1a, and guided to the eye point EP after being reflected inside the transparent cover 23.

Because the irregular light L1b has been conventionally guided to the eye point EP at substantially the same luminance as the regular light L1a, the virtual image S made by the regular light L1a is visually recognized, and a virtual image made by the irregular light L1b is also visually recognized. The virtual images S are thereby visually recognized as a double image.

In contrast to this, the inner surface portion 232 of the transparent cover 23 according to an embodiment has the incidence surface 232b with an incidence angle θ of 65° or less. The incidence angle θ is an angle at which the irregular light L1b enters the incidence surface 232b. That is, the inner surface portion 232 of the transparent cover 23 is provided in such a manner that the incidence angle θ at which the irregular light L1b enters the incidence surface 232b becomes 65° or less. In addition, because the outer surface portion 231 of the transparent cover 23 is curved along the shape of the inner surface portion 232, an incidence angle at which the irregular light L1b enters an incidence surface of the outer surface portion 231 becomes approximately the same as the incidence angle θ of the inner surface portion 232. The incidence angle θ is an angle with respect to a normal line N. Here, by setting the above-described incidence angle θ to 65° or less, the head-up display device 1 can make a reflectance at which the irregular light L1b is reflected inside the transparent cover 23, relatively smaller, and can consequently set the luminance of the irregular light L1b with respect to the luminance of the regular light L1a, to 2% or less. In this manner, because the luminance of the irregular light L1b with respect to the luminance of the regular light L1a becomes 2% or less, even in a case where the irregular light L1b is guided to the eye point EP, the head-up display device 1 can prevent a virtual image made by the irregular light L1b, from being visually recognized. In addition, in the case of setting the luminance of the irregular light L1b with respect to the luminance of the regular light L1a, to 2% or less, the head-up display device 1 considers the material of the transparent cover 23, the reflectance of the inner surface portion 232 and the outer surface portion 231, and the like.

As described above, the head-up display device 1 according to an embodiment includes the display unit 20 and the housing 10. The display unit 20 is provided in a vehicle, and displays the virtual image S by reflecting the display light L1 emitted toward the window shield WS that can transmit light, on the window shield WS toward the eye point EP side. The housing 10 has the opening 11 facing the window shield WS, and the display unit 20 is attached thereto. The above-described display unit 20 includes the display instrument 21, the reflection mirror 22, and a transparent cover 23. The display instrument 21 is accommodated inside the housing 10, and emits the display light L1. The reflection mirror 22 is accommodated inside the housing 10, and reflects the enlarged display light L2 obtained by enlarging the display light L1 emitted from the display instrument 21, toward the window shield WS via the opening 11. The transparent cover 23 blocks the opening 11, and transmits the enlarged display light L2 reflected by the reflection mirror 22. The above-described transparent cover 23 includes the inner surface portion 232 positioned on the reflection mirror 22 side, and the outer surface portion 231 positioned on the opposite side of the reflection mirror 22 side. Here, the display light L1 guided to the eye point EP includes the regular light L1a transmitted through the transparent cover 23 without being reflected by the inner surface portion 232 and the outer surface portion 231 of the transparent cover 23, and guided to the eye point EP, and the irregular light L1b transmitted through the transparent cover 23 after being reflected by the inner surface portion 232 and the outer surface portion 231 of the transparent cover 23, and guided to the eye point EP. The inner surface portion 232 of the transparent cover 23 has the incidence surface 232b with an incidence angle θ of 65° or less. The incidence angle θ is an angle at which the irregular light L1b enters the incidence surface 232b. In other words, the inner surface portion 232 of the transparent cover 23 has the incidence surface 232b that the irregular light L1b enters at an angle that sets the luminance of the irregular light L1b with respect to the luminance of the regular light L1a, to 2% or less.

With this configuration, because the head-up display device 1 can make the luminance of the irregular light L1b to be guided to the eye point EP, smaller than the luminance of the regular light L1a, it is possible to prevent an occupant from visually recognizing the virtual image S made by the irregular light L1b. The head-up display device 1 can thereby prevent a virtual image made by the irregular light L1b, from being visually recognized as a double image, and can consequently appropriately display the virtual image S made by the regular light L1a.

In the head-up display device 1, the free curved surface 232a that performs aberration correction on the enlarged display light L2 reflected by the reflection mirror 22 is formed on the incidence surface 232b. With this configuration, by the free curved surface 232a of the transparent cover 23, the head-up display device 1 can correct the aberration of the virtual image S caused by an optical member including the window shield WS and the like. Then, by performing role sharing of assigning the function of aberration correction mainly to the transparent cover 23, and assigning an enlarging function to the reflection mirror 22, the head-up display device 1 can improve the accuracy of aberration correction and enhance an enlargement factor. Because the head-up display device 1 can reduce the number of parameter coefficients by performing role sharing, the head-up display device 1 can be easily manufactured, and tolerance can be made smaller. By the transparent cover 23 that blocks the opening 11 of the housing 10, also having the function of aberration correction, the head-up display device 1 can suppress an increase in the number of components, and prevent upsizing of an optical system. The head-up display device 1 can consequently appropriately display the virtual image S.

In the head-up display device 1, the display instrument 21 directly emits the display light L1 to the reflection mirror 22. The reflection mirror 22 reflects the enlarged display light L2 obtained by enlarging the display light L1 directly emitted from the display instrument 21, toward the window shield WS via the transparent cover 23. With this configuration, because the display instrument 21 of the head-up display device 1 directly emits the display light L1 to the reflection mirror 22 not via another mirror, the device can be downsized.

In addition, in the above description, an example in which the free curved surface 232a that performs aberration correction is formed on the incidence surface 232b has been described, but the example is not limited to this, and the free curved surface 232a that performs aberration correction needs not be formed.

An example in which the display instrument 21 directly emits the display light L1 to the reflection mirror 22 not via another mirror has been described, but the example is not limited to this, and the display instrument 21 may indirectly emit the display light L1 to the reflection mirror 22 via another mirror.

An example in which the free curved surface 232a is formed on the reflection mirror 22 side of the transparent cover 23 (i.e., the inner surface portion 232) has been described, but the example is not limited to this, and the free curved surface 232a may be formed on the opposite side of the reflection mirror 22 side of the transparent cover 23.

In addition to the function of correcting aberration of the virtual image S by the free curved surface 232a, the transparent cover 23 may have a function of enlarging the enlarged display light L2 (image). In this case, the transparent cover 23 enlarges the enlarged display light L2 (image) at an enlargement factor smaller than an enlargement factor of the reflection mirror 22. For example, the transparent cover 23 enlarges the enlarged display light L2 (image) at an enlargement factor about 1/10 of the enlargement factor of the reflection mirror 22.

In addition to the function of enlarging the display light L1 (image) by the reflection surface 221, the reflection mirror 22 may have a function of correcting aberration of the virtual image S. In this case, the reflection mirror 22 corrects aberration of the virtual image S by an aberration correction amount smaller than that of the transparent cover 23. For example, the reflection mirror 22 corrects aberration of the virtual image S by an aberration correction amount about 1/10 of an aberration correction amount of the transparent cover 23.

An example in which the reflection member is the window shield WS has been described, but the reflection member is not limited to this, and may be a combiner or the like, for example.

Because the head-up display device according to the present embodiment can make the luminance of irregular light to be guided to the eye point, smaller than the luminance of regular light, it is possible to prevent an occupant from visually recognizing a virtual image made by irregular light. The head-up display device can thereby prevent a virtual image made by irregular light, from being visually recognized as a double image, and can consequently appropriately display a virtual image made by regular light.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head-up display device comprising:
a display unit that is provided in a vehicle and that display a virtual image by reflecting display light emitted toward a reflection member capable of transmitting light, by the reflection member toward an eye point side; and
a housing having an opening facing the reflection member, to which the display unit is assembled,
wherein the display unit includes a display instrument that is accommodated inside the housing, and emits the display light,
a reflection mirror that is accommodated inside the housing, and reflects enlarged display light obtained by enlarging the display light emitted from the display instrument, toward the reflection member via the opening, and
a transparent cover that blocks the opening, and transmits the enlarged display light reflected by the reflection mirror,
the transparent cover includes a first surface portion positioned on the reflection mirror side, and a second surface portion positioned on an opposite side of the reflection mirror side,
the display light guided to the eye point includes regular light transmitted through the transparent cover without being reflected by the first surface portion and the second surface portion of the transparent cover, and guided to the eye point, and irregular light transmitted through the transparent cover after being reflected by the first surface portion and the second surface portion of the transparent cover, and guided to the eye point, and
the first surface portion of the transparent cover has an incidence surface with an incidence angle of 65° or less, the incidence angle being an angle at which the irregular light enters the first surface portion, and the incidence surface causes the irregular light to enter at an angle that sets the luminance of the irregular light with respect to the luminance of the regular light, to 2% or less.

2. The head-up display device according to claim 1, wherein a free curved surface that performs aberration correction on the enlarged display light reflected by the reflection mirror is formed on the incidence surface.

3. The head-up display device according to claim 1,
wherein the display instrument directly emits the display light to the reflection mirror, and
the reflection mirror reflects the enlarged display light obtained by enlarging the display light directly emitted from the display instrument, to the reflection member via the transparent cover.

4. The head-up display device according to claim 2,
wherein the display instrument directly emits the display light to the reflection mirror, and
the reflection mirror reflects the enlarged display light obtained by enlarging the display light directly emitted from the display instrument, to the reflection member via the transparent cover.
